(19) United States
(12) Patent Application Publication
(10) Pub. No.: US 2012/0132620 A1
(43) Pub. Date: May 31, 2012

(54) Secure check code scanner

(76) Inventors: Silvano Guidotti, Rignano D. Arno (FI) (IT); Paolo Ravenni, Pontassieve (IT); Massimo Scardigli, Livomo (IT); Shane Kirk, Durham, NC (US)

(21) Appl. No.: 12/927,908

(22) Filed: Nov. 29, 2010

(51) Int. Cl. B44C 1/22; B28B 17/00; B05C 11/00; B29C 35/08; B24B 1/00; B05D 1/02

(52) U.S. Cl. 216/85; 451/67; 451/28; 427/421.1; 118/708; 156/345.24; 264/400; 425/135

(57) ABSTRACT

A device and method for secure check processing in a paper check scanning device that scans the identification encoding characters on the surface of a paper check, creating an electronically digitized record of the scanned physical identification indicators, transmitting the digitized record of the indicators to a verification unit, and awaiting validation and acceptance of the digitized record. The digitized record may be validated and accepted either through an electronic processing system or manually by human validation personnel. After the digitized record has been accepted the acceptance notification is sent to the check scanner. Upon receipt of the validation and acceptance of the digitized record of the paper check, the secure check scanner moves the paper check into position and the encoded identification characters on the paper check are altered by removing the area of the paper check containing the identification characters to render the paper check unscannable.

This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Paper checks used to purchase goods are generally submitted to a bank for deposit on a periodic basis. Banks, and some large retailers, generally electronically digitize the checks at remote sites such as branch banking locations or retail locations and scan the physical paper check to form an electronic record of the check to be deposited. The scanned and digitized check is converted to an image deposit file, or image cash letter, that is then deposited through a clearing house, such as the Federal Reserve clearing house or an alternate clearing house. The deposit process for the check image deposit files is performed in accordance with Federal Reserve Regulations and/or NACHA operating rules.

After scanning and conversion, the paper checks are no longer required by the bank or retailer and may be returned to the originator of the check, or they may be disposed of in a secure fashion. The electronic record captured in the image deposit file for each check is maintained in a secure data environment. Paper checks may be less secure from the time they are first scanned until they are destroyed or returned to the check originator.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a side view of the check scanner apparatus with an attached security mechanism consistent with certain embodiments of the present invention.

FIG. 2 is a cutaway of the check scanner apparatus with attached security mechanism consistent with certain embodiments of the present invention.

FIG. 3 is an isolated view of the actuator solenoid and lever components of the security mechanism apparatus consistent with certain embodiments of the present invention.

FIG. 4 is a detailed internal view of the check scanner apparatus with attached security mechanism consistent with certain embodiments of the present invention.

FIG. 5 is a top-down, cutaway view of the check scanner apparatus with the attached security mechanism consistent with certain embodiments of the present invention.

FIG. 6 is a bottom-up, cutaway view of the check scanner apparatus with the attached security mechanism consistent with certain embodiments of the present invention.

FIG. 7 is a flow diagram of the operation of the secure check scanner consistent with certain embodiments of the present invention.

FIG. 8 is a detailed flow diagram of check alteration in the secure check scanner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “program” or “computer program” or similar terms, as used herein, is defined as a sequence of instructions designed for execution on a computer system or for execution on/in an embedded microcontroller system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system or for execution on/in an embedded microcontroller system.

Paper checks submitted for deposit to a branch Bank, large retailer, or other institution that may scan and electronically digitize checks submitted for payment of debts or purchases may not be completely secure from re-deposit either through a second scan and electronic digitization or physical presentment of the original paper instrument to a bank or other deposit/cashing institution. The re-deposit action may be caused by inattention or mistake on the part of a technician charged with the duty of creating the image deposit files for a large number of checks. Alternatively, paper checks may be submitted for re-deposit intentionally by an unscrupulous person, or persons, who secures paper checks after they have been initially scanned and digitized but before they have been destroyed, returned to an originator, or otherwise rendered incapable of re-deposit.

Although security measures are in place in such institutions to attempt to verify that all paper checks have been deposited only once, these security measures may be side-stepped by a well-meaning employee as a mistake, or by unscrupulous persons committing a criminal action. Often the duplicate image deposit file for a re-submitted paper check is not discovered until a reconciliation of checks is performed by the clearing house. At this point in time, the second payment of the paper check may have been moved to a different, unknown financial account and the bank or other institution that deposited the paper check initially is responsible for the loss of funds from the subsequent deposit of a paper check.

Re-deposit of a paper check may be curtailed, or eliminated through the use of a device that physically alters the paper check in an unrecoverable fashion. When a paper check is submitted to a bank or other institution that may scan and electronically digitize the paper check to create the image deposit file, the image deposit file may be checked for errors and completeness, and then the paper check may be processed such that vital fields are changed or removed. In an exemplary implementation, modifying the Magnetic Ink Character Recognition (MICR) line, also identified as the code-line, that contains routing and account information on the bottom of each paper check such that the fields are no longer complete would render the paper check incapable of being re-submitted. The alteration or removal of the MICR line would not allow the check to be processed because the check would be missing data needed to process the paper check for submission. In addition, the alteration or removal of the MICR line would be instantly recognizable to a technician making an innocent mistake and would allow the technician to remove the check from the processing batch as having already been deposited.

A check scanner is a device whose function is to digitize the information contained on a physical paper check consisting of front and or rear digitizing CCD image sensors, CIS image sensors or image cameras that work by taking a digital picture of the front and or rear of the check and sending that data to the host computer. Also sometimes included is a magnetic read head element that digitizes the MICR code-line information and passes that information to the host computer. Alternatively, or in addition to the magnetic read head, software can be used to read from the digital image through Optical Character Recognition the data contained in the MICR code line.

The description below presents a device and method for altering a physical paper check to prevent re-deposit of that physical paper check after the physical paper check has been digitally converted to create an image deposit file. This device and method provide for a secure scan and image deposit file creation at a remote location through the use of a secure check code scanning device and associated scanning and operation software modules.

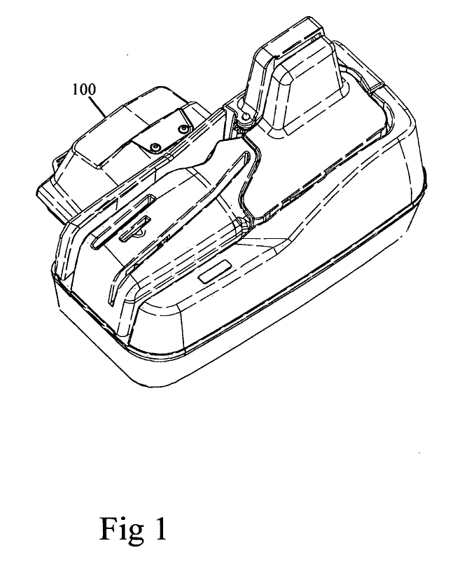

Turning now to FIG. 1, in an exemplary embodiment a check scanning unit 100 is presented that accepts paper checks and scans the front and back surfaces of the paper check to produce both a digital image of both surfaces of the paper check. The check scanner 100 also scans the MICR information that is embossed on the front side of all paper checks. The MICR characters on each paper check present a routing number that refers to the clearing house bank to which the paper check, or its digital image record, is to be routed, the originating bank information, and the account number information for the account the paper check is drawn upon. In this exemplary embodiment, a paper check is inserted into the check scanning device and moved mechanically through the device where it may be positioned proximate to a check alteration mechanism 104.

The check alteration mechanism 104 may be physically attached on one side of the check scanner 100 or may be attached to the check scanner 100 through a data communications or network connection. In this non-limiting example the check alteration mechanism 104 is attached to the check scanner 100. The check scanner 100 accepts a paper check that may be scanned to produce a digital record of the paper check. The paper check is held within the scanner while the digital record is reviewed. If the review indicates that the digital record of the check is accepted, an acceptance indication is provided to the check scanner 100. Check acceptance may be based upon the presence of one or more of a set of pre-defined physical parameters, system restrictions pre-determined for the paper check review activity, or other parameters defined as acceptance parameters. Human review of the digital record may also be a pre-determined factor for acceptance of a paper check. Upon acceptance, the check scanner 100 positions the paper check in a pre-determined position proximate to the check alteration mechanism 104. To properly position the paper check, the check scanner 100 may move the paper check in forward or backward directions through the check scanner 100 to position the paper check in the proper position for activation of the check alteration mechanism 104. Upon proper positioning, the check alteration mechanism 104 may activate and physically alter the surface and/or the code-line of the paper check.

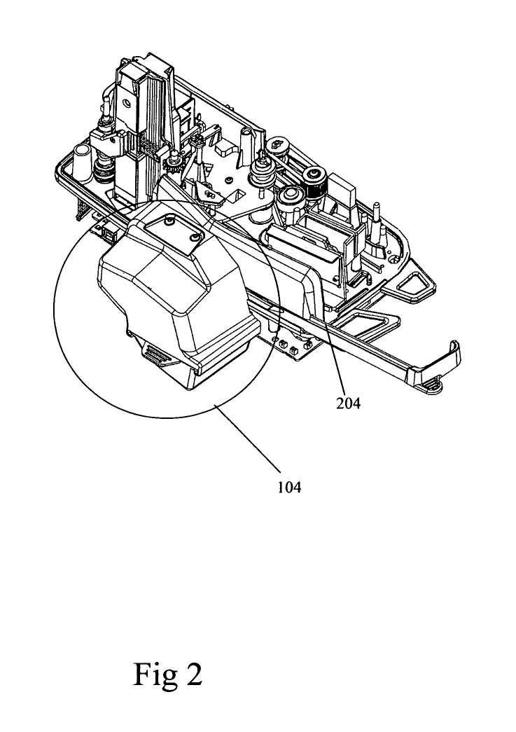

Turning now to FIG. 2, in an exemplary embodiment a check scanning unit 100 with a physically attached check alteration mechanism 104 is presented in a cutaway view. A check alteration mechanism 104 may, in an alternative non-limiting example, be physically separate from the check scanner 100 but be connected to the check scanner 100 through a data communications connection (not shown). The check alteration mechanism 104 may be attached to a check scanning unit 100 that may be connected to a local computer system. Alternatively, the check scanning unit 100 and check alteration mechanism 104 may be connected to a network through a data communication connection, allowing the check scanning unit 100 to perform as a stand-alone device as a network capable peripheral, or operable without'a computer or computer network data connection. In a non-limiting example, the check scanner 100 operating as a stand-alone unit without a computer or network data connection may store the scanned paper check digital record into a memory card, or other separable storage device such as a flash drive, associated with the check scanner 100. The memory card or other separable storage device may then be removed from the check scanner 100 and the data downloaded to a computer processor or computer network server for further processing.

In this non-limiting example, the check alteration mechanism 104 is attached proximate to the check travel channel 204 along which the paper check may be positioned. As seen in this cutaway view, a paper check may be positioned within the check travel channel 204 such that it is positioned proximate to the check alteration mechanism 104 such that the check alteration may be accomplished while the paper check is in position.

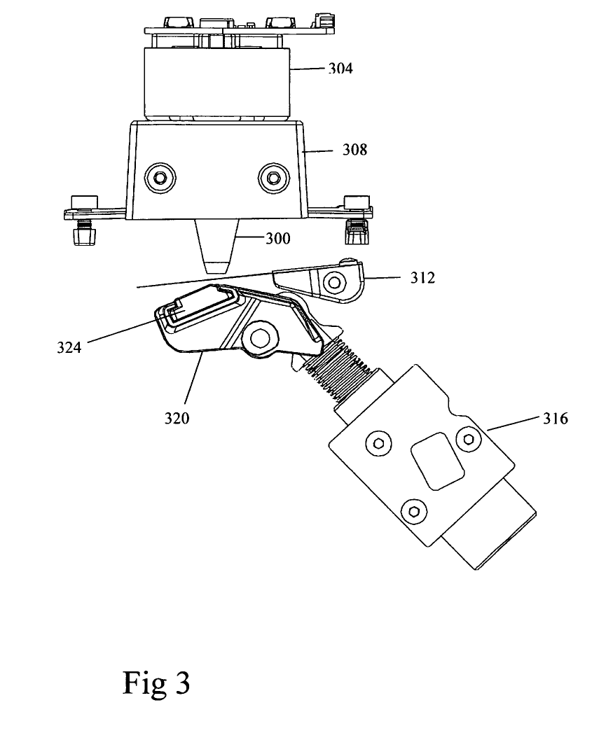

Turning now to FIG. 3, in an exemplary embodiment the check alteration mechanism 104 mechanical components are presented. The check alteration mechanism 104 is responsible for the physical alteration of the surface of a paper check in any fashion that will render the identification characters, such as, in an illustrative example, the MICR line on the front of the paper check, sufficiently physically altered such that the identification characters will no longer produce an intelligible identification upon subsequent scanning of the altered paper check. In the exemplary embodiment presented the alteration mechanism may consist of a punch 300 that physically removes a portion of the MICR line when activated. The alteration mechanism is presented with a punch 300 as the physical alteration mechanism; however, in additional exemplary embodiments the physical alteration mechanism may be a device for sanding, burning, scraping, etching, spraying, or any other action that may physically alter the surface of the paper check.

In the exemplary embodiment, the punch 300 is operated by a punch motor 304 and both the punch 300 and punch motor 304 are installed within a punch housing 308 that positions the mechanism within the check scanner. When the digital record of the image and information from a paper check has been accepted and the paper check is to be physically altered, the paper check is moved into position proximate to the punch 300 and supported in position by the check support 312. When activated, the punch solenoid 316 extends pushing the punch lever 320 toward the paper check with the punch rubber 324 coming into contact with the paper check. The punch rubber 324 pushes against the paper check with sufficient force to push the paper check against the punch 300. The punch 300 removes the portion of the paper check in contact with the punch 300 through a drilling or punching action such that the portion of the MICR line that is in contact is physically removed, thus altering the paper check permanently. The paper check may then be positioned such that another section of the MICR line is positioned in front of the punch 300 such that the next activation of the solenoid 316 once again pushes the punch lever 320 forward, pushing the paper check against the punch 300 such that another portion of the MICR line is physically removed from the paper check. This reposition and activation continues until a pre-determined portion of the MICR line sufficient to ensure that the paper check may not be re-scanned is removed.

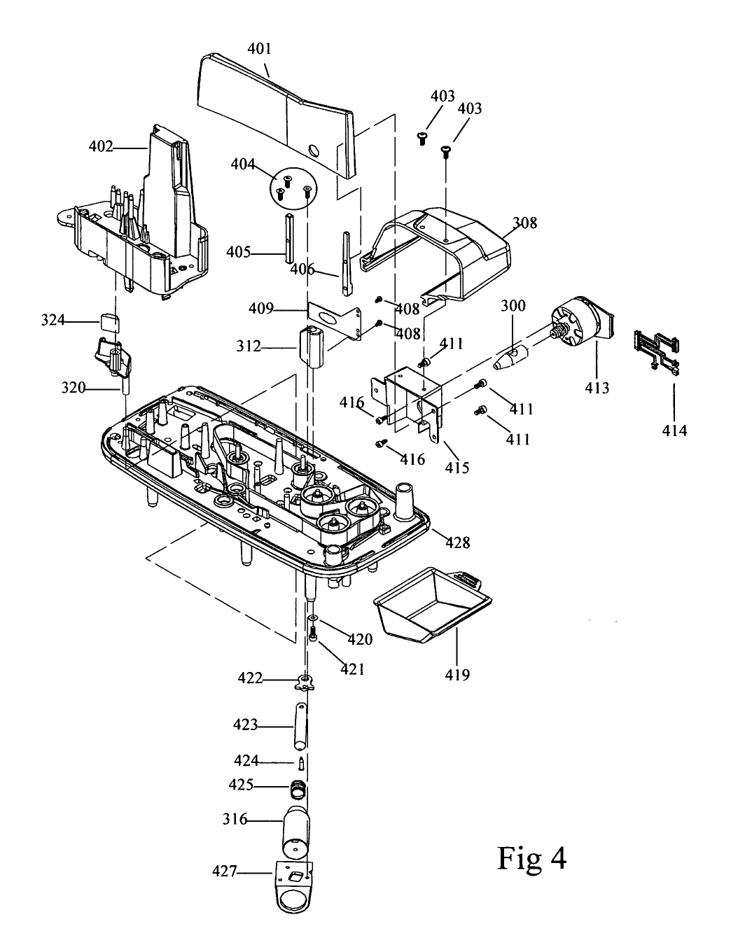

Turning now to FIG. 4, in an exemplary embodiment a detailed internal view of the check scanner apparatus with attached security mechanism is presented. The individual components that constitute the check alteration security mechanism include the Contact Image Sensor (CIS) which includes the rear bulkhead 401 and the internal CIS support 402. The paper check passes through the CIS and is then held in a wait position before being re-positioned proximate to the punch 300 and the punch assembly which, in this exemplary implementation includes the punch motor 304 which is attached to the punch motor support 415. The punch motor support 415 is attached to the check scanner hollow punch plate 428 and secured in place by attachment to a short bulkhead 415 and a long bulkhead 416 through the use of three dedicated screws 411. The punch motor 304 is attached to the punch motor support 415 through the use of two screws 416. An activation cable 414 that supplies power and activation signals to the punch motor 304, including timing signals, is attached to the punch motor 304 at the opposite end of the punch assembly from the punch 300. The entire punch assembly is protected from dust and damage by a punch motor cover 308 that is attached to the punch motor support 415 through the use of two screws 413. A punch chad box 419 is slideably attached to the bottom of the punch motor support 415 such that the punch chad box 419 may be removed for cleaning and maintenance.

The check support 312 holding the paper check in a wait position is attached to a support lever 409 by two screws 408. The paper check is repositioned from the wait position through the check scanners “native” check transport mechanism. The main drive motor is activated, which in turn moves the feed belt and pulleys/wheels to position the check. Once the paper check is properly positioned the paper check is altered through the activation of the solenoid assembly. The solenoid assembly is composed of a solenoid 316 installed within a solenoid support 427 and is connected to a solenoid spring 425, a solenoid core stud 424, a solenoid core 423, and a solenoid joint 422 to complete the solenoid assembly. The solenoid assembly is connected to the bottom side of the hollow punch plate 428 through the use of a washer 420 and screw 421. The solenoid 316, when activated, pushes the hollow punch lever 320 forward with sufficient force to place the hollow punch rubber 324 against the surface of the paper check to move the paper check against the punch 300. The paper check is held against the punch lever 309 by the action of the solenoid 316 for a time sufficient for the punch 300 to physically remove a portion of the MICR code-line of the paper check. The action of the punch 300 produces a punch chad that drops into the punch chad box 419.

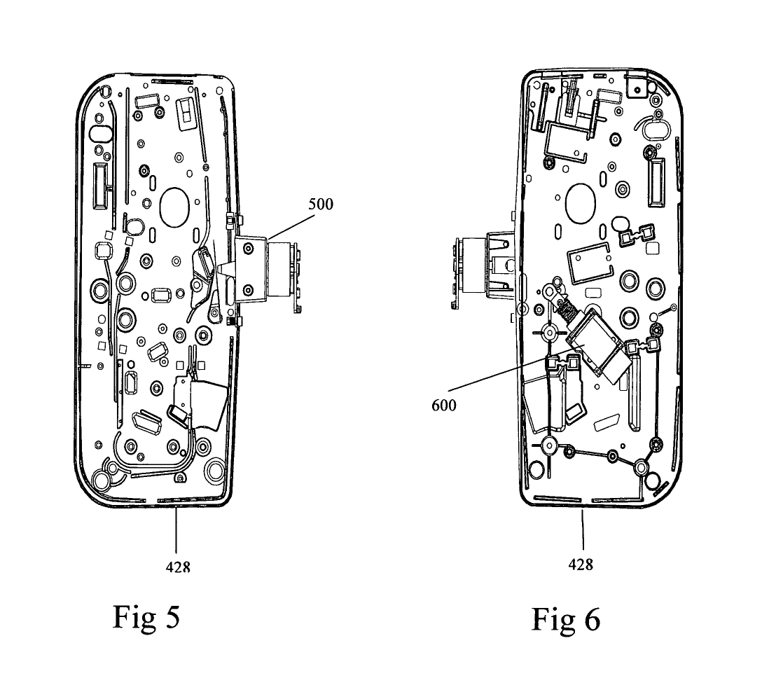

Turning now to FIG. 5, in an exemplary embodiment a top-down, cutaway view of the check scanner apparatus with the attached security mechanism is presented. The complete punch assembly 500 is attached to the upper side of the hollow punch plate 428 of the apparatus. In this exemplary embodiment, the punch assembly 500 is only one solution to the need for physically altering the MICR line of identifying indicators on the surface of a paper check. The punch assembly 500 could be replaced by an alteration assembly apparatus that is capable of other methods of physically altering the identifying indicators such as an assembly for sanding, burning, scraping, spraying or etching away the MICR line characters.

Turning now to FIG. 6, in an exemplary embodiment a bottom-up, cutaway view of the check scanner apparatus with the attached security mechanism is presented. The complete solenoid assembly 600 is attached to the bottom side of the hollow punch plate 428 of the apparatus. When activated, the solenoid action is sufficient to press the paper check firmly against a check bulkhead lever and hold the paper check in place during the alteration action by the alteration apparatus.

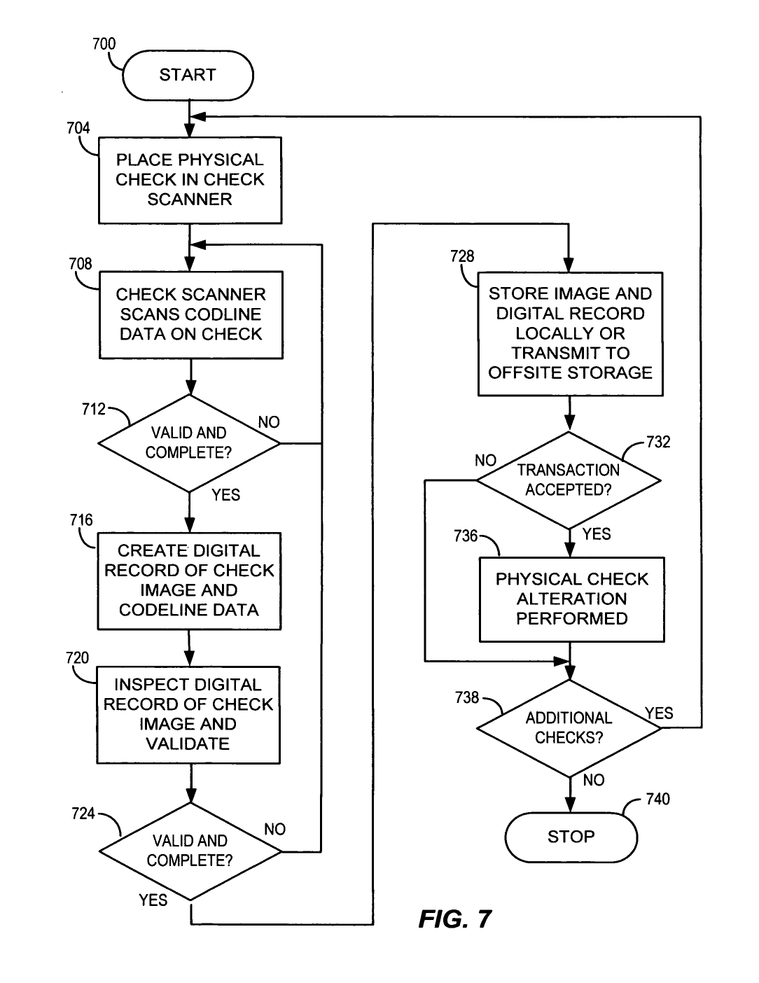

Turning now to FIG. 7, a flow diagram of the operation of the secure check scanner is presented. In an exemplary implementation the operation of the secure check scanner begins with the placement of a physical paper check into the check scanner 704. At 708, the check scanner performs both an image scan and a code scan to produce a digital record of the image and all routing, bank, and account coding information from the paper check. The routing, bank, and account coding information are identification indicators that are encoded in the MICR characters printed in the code-line on the front surface of the paper check. At 712, the check scanner performs a verification action to determine that the image and encoded information from the check is complete and that the image and encoded identification information are valid. If the scanned data are not valid, the check scanner returns the paper check to the beginning position and scans the check once again.

With valid and complete image and identification data scanned from the paper check at 716 the check scanner creates a digital record of the check image and the code-line data that includes all of the identification information from the check. At 720 an inspection process is performed to verify that the digital record is both visible and accurate. The inspection process may be performed either visually by a human operator, or the inspection may be performed electronically through the use of a check validation process. At 724, the inspection process may determine that the image is not visibly accurate or that the scanned identification data is not accurate. If the image and/or identification data are not valid or complete the paper check may be returned to the beginning position to be scanned again or a human operator may correct data in order for the transaction to be validated.

If the image and identification data are valid and complete the inspection process will accept the data and at 728 the digital record of the image and identification data of the scanned paper check may be stored. The digital record of the scanned paper check may be stored in local storage that is attached to the check scanner or local host computer, or the digital record may be transmitted to offsite storage through a network or other data communication channel. Paper check validation is performed by comparing and matching scanned physical parameters from the paper check with pre-determined parameters. A software module may be programmed to perform verification comparisons for the presence of a signature on the paper check, issue date, an entry for the “pay to” line on the paper check, courtesy amount and legal amount information present on the paper check image. The paper check image may then be analyzed by an image quality analysis software module that may perform an analysis for the presence or absence of pre-determined characteristics that may include image too dark, image too light, dog eared, file size too large, file size too small, and other pre-determined parameters that must be met. The paper check digital image may also be transmitted to a user display where a human operator may perform the paper check validation comparisons to determine validity of the paper check scan action.

At 732, the check scanner awaits an indicator from the storage device, network server, or other validation computer processor that the transaction has been accepted. The acceptance indicator may be an electronic signal from a computer validation module indicating that all of the parameters of the digital record are valid and the digital record of the paper check is legible and validated. Alternatively, a human operator may input a character or other signal as an acceptance indicator to the computer processor in communication with the check alteration mechanism to indicate that the digital record of the paper check is legible and validated. If the transaction is indicated as accepted, at 736 the check alteration mechanism will be engaged and the physical alteration of the paper check will be performed. If the transaction is not indicated as accepted, the digital record will not be saved and the check will be placed in the queue to be processed once again by the check scanner, or, alternatively, the paper check may be processed through an alternate mechanism.

At 738 the check scanner, control program, or human operator may determine that additional paper checks must be processed. If additional checks are to be processed the process returns to the beginning step at 704 and awaits the placement of next paper check within the check scanner. If there are no more checks to be processed at this time the process terminates at 740.

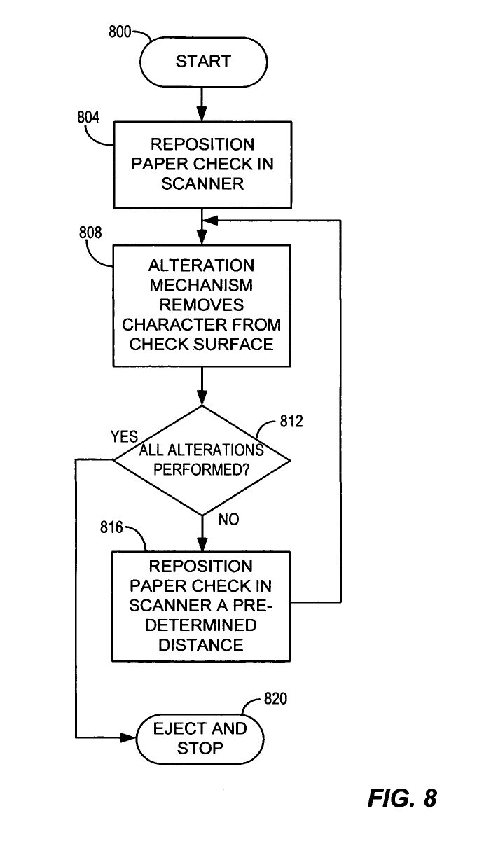

Turning now to FIG. 8, a detailed flow diagram of check alteration in the secure check scanner is presented. Upon receipt of an acceptance of the digital record for a paper check being scanned, the check scanner at 804 repositions the paper check proximate to the alteration mechanism. In a non-limiting example, the alteration mechanism may consist of a paper punch that may remove a portion of the paper check that is positioned proximate to the punch when activated. The check scanner may move the paper check in either forward or backward directions to position the paper check in the proper position for the paper punch to remove the first, last, or any other desired character from the MICR codeline identification characters. After the paper check is in the pre-determined position the alteration mechanism is activated to remove the portion of the MICR codeline that is positioned proximate to the alteration mechanism. In a non-limiting example, the alteration mechanism may consist of a punch that is capable of punching through the paper check and removing a portion of the codeline from the paper check. The removed portion, which may consist of a paper chad, drops into a cup positioned to capture the paper chads from the operation. In other non-limiting examples, the portion of the MICR code-line positioned proximate to the alteration mechanism may be scraped, burned, sanded, sprayed or removed in any other fashion that may reliably alter the surface of the paper check so as to make the MICR code-line characters unscannable or unreadable either mechanically or by the human eye.

The check scanner may then check to determine if all iterations of the alteration mechanism action have been performed to remove MICR code-line portions at 812. A pre-programmed number of iterations for the alteration action may be performed. The pre-programmed number of iterations may be pre-determined and installed in the operation programming firmware for the check scanner. In an alternative non-limiting example, a user may be presented with an option during the setup of the check scanner to input the pre-programmed number of iterations to complete the alteration activity. The pre-programmed number of alteration actions may alter the paper check sufficiently to render the paper check code-line unscannable and unreadable, mechanically and visually. If the pre-programmed number of alteration actions has not been completed, at 816 the check scanner may reposition the paper check such that a non-altered portion of the surface of the paper check is placed in position proximate to the alteration mechanism such that the next action of the alteration mechanism will remove another portion of the MICR code-line. The operation process then returns to the alteration step of the procedure at 808. If the check scanner or control software determines that all of the pre-programmed alteration actions have been performed such that the paper check can no longer be processed nor be readable either mechanically or by the human eye, the check scanner may eject the paper check from the scanner and stop operation at 820.

A scanning device for scanning physical identification indicators on a paper check may scan a paper check and create an electronically digitized record of the scanned physical identification indicators, transmit the digitized record of the indicators to a verification unit, and await validation and acceptance of the digitized record. Upon receipt of the validation and acceptance of the digitized record from the validation unit, the scanning device may physically alter the physical identification indicators on the paper check to render the physical identification indicators illegible and unscannable.

The forward and reverse motion actions to move the paper check back into the scanning device and place it in position for physical alteration. The physical identification indicators may include Magnetic Ink Character Recognition (MICR) or Optical Character Recognition (OCR) characters. The electronically digitized record is created through the operation of front and/or rear digitizing CCD image sensors, CIS image sensors, or image cameras to capture a digital image of the paper check. The scanning device may be in data communication over a network communication channel with the validation unit and the validation unit communicates an acceptance of the received digital image. The apparatus may position the paper check proximate to a check alteration mechanism associated with the scanning device for physical alteration of the paper check. The check alteration mechanism may have mechanical components to physically alter the identification indicators on the surface of the paper check. The physical alteration of the identification indicators may be accomplished through removing or altering the area of the paper check containing the identification indicators through any of drilling, sanding, scraping, etching, spraying of ink or other chemicals, or laser burning the paper check to physically remove the identification indicators.

A method for secure check processing begins with inserting a paper check in a check scanning device. A check scanner scans the physical identification indicators on the surface of the paper check, creating an electronically digitized record of the scanned physical identification indicators. The check scanner transmits the digitized record of the indicators to a verification unit, and awaits validation and acceptance of the digitized record. The check scanner receives the validation and acceptance of the digitized record from the validation unit and alters through a physical interaction with the paper check the physical identification indicators on the paper check to render the physical identification indicators unusable for identification either visually or via subsequent scan operations.

The check scanner reverses the motion to move the paper check back into the scanning device and place it in position for physical alteration. The physical identification indicators may include Magnetic Ink Character Recognition (MICR) or Optical Character Recognition (OCR) characters. The check scanner creates the electronically digitized record through the operation of front and/or rear digitizing CCD image sensors, CIS image sensors, or image cameras to capture a digital image of the paper check. The check scanning device may be in data communication over a network communication channel with the validation unit, and the validation unit communicates an acceptance of the received digital image to the scanning device. The scanning device positions the paper check proximate to a check alteration mechanism within the scanning device for physical alteration of the paper check.

Alter the paper check through the operation of a check alteration mechanism associated with the scanning device that physically alters the identification indicators on the surface of the paper check. The physical alteration of the identification indicators comprises removing the area of the paper check containing the identification indicators through any of drilling, sanding, scraping, etching, or laser burning the paper check to physically remove the identification indicators.

A secure check processing process may require inserting a paper check in a check scanning device, scanning physical identification indicators on the surface of the paper check to create a digital image and digitized record of the paper check. The process may create an electronically digitized record of the scanned physical identification indicators, transmit the digitized record of the indicators to a verification unit, and await validation and acceptance of the digitized record. The process receives the validation and acceptance of the digitized record from the validation unit and alters through a physical interaction with the paper check the physical identification indicators on the paper check by removing the area of the paper check containing the identification indicators to physically remove the identification indicators rendering the physical identification indicators unusable for identification.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. An apparatus comprising:
a scanning device for scanning physical identification indicators on a paper check;
the scanning device creating an electronically digitized record of the scanned physical identification indicators, transmitting the digitized record of the indicators to a verification unit, and awaiting validation and acceptance of the digitized record;
upon receipt of the validation and acceptance of the digitized record from the validation unit, the scanning device physically altering the physical identification indicators on the paper check to render the physical identification indicators illegible and unscannable.

2. The apparatus of claim 1, further comprising forward and reverse motion actions to move the paper check back into the scanning device and place it in position for physical alteration.

3. The apparatus of claim 1, wherein the physical identification indicators comprise Magnetic Ink Character Recognition (MICR) or Optical Character Recognition (OCR) characters.

4. The apparatus of claim 1, where the electronically digitized record is created through the operation of front and/or rear digitizing CCD image sensors, CIS image sensors, or image cameras to capture a digital image of the paper check.

5. The apparatus of claim 1, where the scanning device is in data communication over a network communication channel with the validation unit.

6. The apparatus of claim 5, where the validation unit communicates an acceptance of the received digital image.

7. The apparatus of claim 1, further comprising positioning the paper check proximate to a check alteration mechanism associated with the scanning device for physical alteration of the paper check.

8. The apparatus of claim 7, where the check alteration mechanism comprises mechanical components to physically alter the identification indicators on the surface of the paper check.

9. The apparatus of claim 8, where the physical alteration of the identification indicators comprises removing or altering the area of the paper check containing the identification indicators through any of drilling, sanding, scraping, etching, spraying of ink or other chemicals, or laser burning the paper check to physically remove the identification indicators.

10. A method for secure check processing comprising:
inserting a paper check in a check scanning device;
scanning physical identification indicators on the surface of the paper check;
creating an electronically digitized record of the scanned physical identification indicators, transmitting the digitized record of the indicators to a verification unit, and awaiting validation and acceptance of the digitized record;
receiving the validation and acceptance of the digitized record from the validation unit; and
altering through a physical interaction with the paper check the physical identification indicators on the paper check to render the physical identification indicators unusable for identification either visually or via subsequent scan operations.

11. The method of claim 10, further comprising reversing the motion to move the paper check back into the scanning device and place it in position for physical alteration.

12. The method of claim 10, wherein the physical identification indicators comprise Magnetic Ink Character Recognition (MICR) or Optical Character Recognition (OCR) characters.

13. The method of claim 10, further comprising creating the electronically digitized record through the operation of front and/or rear digitizing CCD image sensors, CIS image sensors, or image cameras to capture a digital image of the paper check.

14. The method of claim 10, where the scanning device is in data communication over a network communication channel with the validation unit.

15. The method of claim 14, where the validation unit communicates an acceptance of the received digital image to the scanning device.

16. The method of claim 10, further comprising positioning the paper check proximate to a check alteration mechanism within the scanning device for physical alteration of the paper check.

17. The method of claim 16, further comprising altering the paper check through the operation of a check alteration mechanism comprising mechanical components in the scanning device that physically alter the identification indicators on the surface of the paper check.

18. The method of claim 17, where the physical alteration of the identification indicators comprises removing the area of the paper check containing the identification indicators through any of drilling, sanding, scraping, etching, or laser burning the paper check to physically remove the identification indicators.

19. A computer readable storage medium storing instructions for secure check processing which, when executed on a programmed processor, comprises:
inserting a paper check in a check scanning device;
scanning physical identification indicators on the surface of the paper check;
creating an electronically digitized record of the scanned physical identification indicators, transmitting the digitized record of the indicators to a verification unit, and awaiting validation and acceptance of the digitized record;
receiving the validation and acceptance of the digitized record from the validation unit; and
altering through a physical interaction with the paper check the physical identification indicators on the paper check by removing the area of the paper check containing the identification indicators to physically remove the identification indicators rendering the physical identification indicators unusable for identification.
